(19) United States
(12) Patent Application Publication
(10) Pub. No.: US 2013/0166924 A1
(43) Pub. Date: Jun. 27, 2013

(54) METHOD FOR PERFORMING SCENARIO DRIVEN VOLTAGE SCALING, AND ASSOCIATED APPARATUS

(71) Applicants: Jen-Chieh Yang, Hsinchu City (TW); Yuh Cheng, Hsinchu County (TW); Kun-Bin Lee, Taipei City (TW); Haw-Kuen Su, Taipei City (TW)

(72) Inventors: Jen-Chieh Yang, Hsinchu City (TW); Yuh Cheng, Hsinchu County (TW); Kun-Bin Lee, Taipei City (TW); Haw-Kuen Su, Taipei City (TW)

(21) Appl. No.: 13/332,371

(22) Filed: Dec. 21, 2011

(51) Int. Cl. G06F 1/26

(52) U.S. Cl. 713/300

(57) ABSTRACT

A method for performing scenario driven voltage scaling of a system includes: monitoring at least one condition of the system, wherein the at least one condition includes user scenario switching of the system; and based upon at least one predetermined table, determining at least one level of at least one voltage for driving the system according to the at least one condition, where the predetermined table includes a plurality of sets of frequency/voltage information respectively corresponding to a plurality of scenarios. An associated apparatus for performing scenario driven voltage scaling of the system is also provided. The apparatus includes at least one tracking module capable of monitoring the at least one condition of the system, and further includes at least one voltage control module capable of determining the at least one level of the at least one voltage.

### BACKGROUND

The present invention relates to power management of a system, and more particularly, to a method for performing scenario driven voltage scaling, and to an associated apparatus.

Power saving is always an important issue for implementation of electronic devices such as mobile phones, personal or portable navigation devices (PNDs), digital cameras, tablets, personal computers, etc., no matter whether the electronic devices are portable or not. In order to reduce the power consumption of the electronic devices, and more particularly, those powered by batteries, conventional methods of the related art typically focus on sacrificing performance of a core circuit such as a Central Processing Unit (CPU) or a Micro Processing Unit (MPU) for power saving. However, when products are implemented based upon the conventional methods, many problems may occur. For example, a sub-system within a related art system may be driven by a single pre-defined voltage, and in a situation where the loading is not heavy, the pre-defined voltage driving the sub-system cannot be changed. In another example, in a situation where some sub-systems within a related art system are not used, the related art system cannot turn off these sub-systems. Thus, the related art does not serve the users well, and therefore, a novel method is required to improve power management of the electronic devices.

### SUMMARY

It is therefore an objective of the claimed invention to provide a method for performing scenario driven voltage scaling, and to provide an associated apparatus, in order to solve the above-mentioned problems.

An exemplary embodiment of a method for performing scenario driven voltage scaling of a system comprises: monitoring at least one condition of the system, wherein the at least one condition comprises user scenario switching of the system; and based upon at least one predetermined table, determining at least one level of at least one voltage for driving the system according to the at least one condition, wherein the predetermined table comprises a plurality of sets of frequency/voltage information respectively corresponding to a plurality of scenarios.

An exemplary embodiment of an associated apparatus for performing scenario driven voltage scaling of a system is provided. The apparatus comprises at least one tracking module and at least one voltage control module. In addition, the at least one tracking module is capable of monitoring at least one condition of the system, wherein the at least one condition comprises user scenario switching of the system. Additionally, based upon at least one predetermined table, the at least one voltage control module is capable of determining at least one level of at least one voltage for driving the system according to the at least one condition, wherein the predetermined table comprises a plurality of sets of frequency/voltage information respectively corresponding to a plurality of scenarios.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram of a system including an apparatus for performing scenario driven voltage scaling of the system according to a first embodiment of the present invention.

FIG. 1B illustrates some implementation details of the apparatus shown in FIG. 1A according to an embodiment of the present invention.

FIG. 2 is a flowchart of a method for performing scenario driven voltage scaling of a system according to one embodiment of the present invention.

FIGS. 3A-3B illustrate some implementation details of the method shown in FIG. 2 according to some embodiments of the present invention.

FIG. 4 illustrates an exemplary table involved with the method shown in FIG. 2 according to an embodiment of the present invention.

FIG. 5 illustrates an exemplary table involved with the method shown in FIG. 2 according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

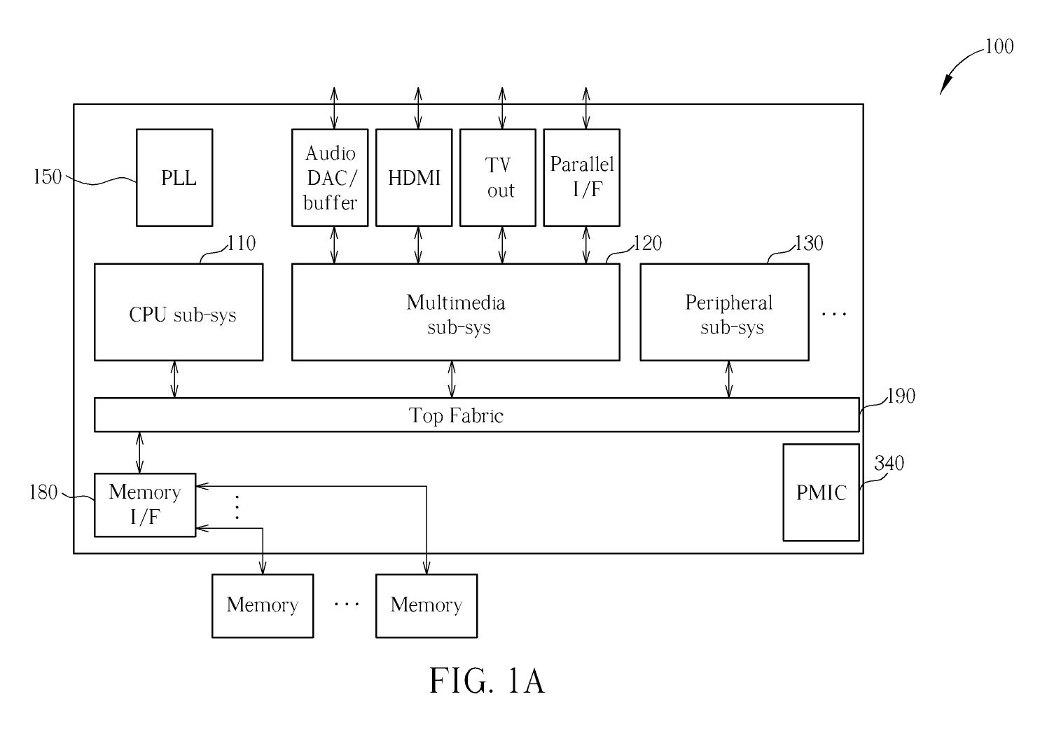

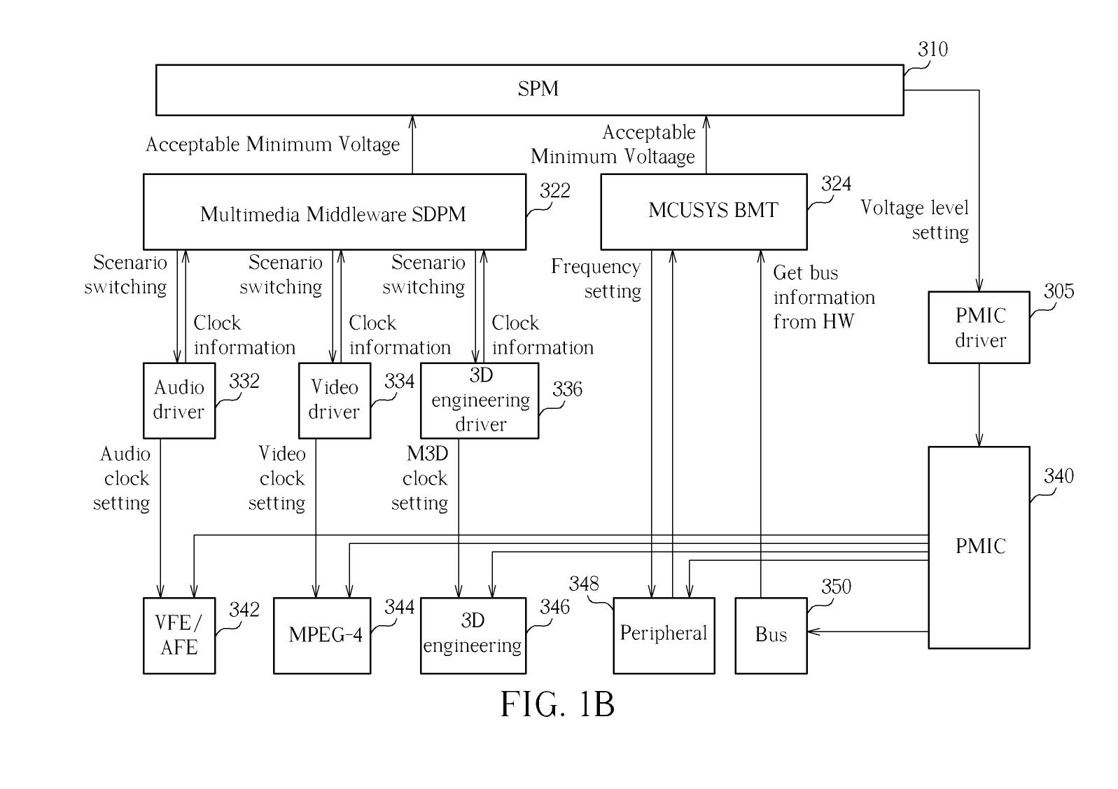

Please refer to FIG. 1A, which illustrates a diagram of a system 100 including an apparatus for performing scenario driven voltage scaling of the system 100 according to a first embodiment of the present invention, where the performance of the system 100 is tunable. Examples of the system 100 may include, but not limited to, personal digital assistants (PDAs), mobile phones, personal or portable navigation devices (PNDs), digital cameras, multifunctional portable electronic devices equipped with PDA functionality, mobile phone functionality, and/or PND functionality, and personal computers (PCs) such as desktop computers and laptop computers. According to this embodiment, the apparatus comprises at least one portion (e.g. a portion or all) of the system 100. For example, the apparatus can be a control chip of the system 100. In another example, the apparatus can be the whole of the system 100. As shown in FIG. 1A, the system 100 can comprise a Central Processing Unit (CPU) sub-system 110 (labeled “CPU sub-sys” in FIG. 1A), a multimedia sub-system 120 (labeled “Multimedia sub-sys” in FIG. 1A), a peripheral sub-system 130 (labeled “Peripheral sub-sys” in FIG. 1A), and some other sub-systems such as a memory interface 180 (labeled “Memory I/F” in FIG. 1A), and further comprises a top fabric 190. In addition, the system 100 may comprise a phase-locked loop (PLL) unit 150 (labeled “PLL” in FIG. 1A) and a power management integrated circuit (PMIC) 340, and may further comprise some input/output (I/O) modules and/or interface modules, such as at least one audio digital-to-analog converter (DAC)/buffer (labeled “Audio DAC/buffer” in FIG. 1A), a high-definition multimedia interface (HDMI), a television (TV) out unit (labeled “TV out” in FIG. 1A), and a parallel interface (labeled “Parallel I/F” in FIG. 1A), which are electronically connected to the multimedia sub-system 120 in this embodiment. Additionally, the system 100 may comprise a security unit (not shown) and a boot read only memory (ROM) (not shown). In practice, the system 100 can be implemented with at least one hardware circuit or at least one software module, or can be implemented with a combination of at least one hardware circuit and at least one software module. This is for illustrative purposes only, and is not meant to be a limitation of the present invention. According to a variation of this embodiment, some other interface modules such as those complying with mobile industry processor interface (MIPI) specifications can be implemented for some sub-systems such as the multimedia sub-system 120 and the peripheral sub-system 130.

According to this embodiment, the CPU sub-system 110 is equipped with a processor such as a CPU (not shown) and associated circuits, and is capable of controlling many operations of the system 100. In addition, the multimedia sub-system 120 is capable of perform audio/video coding (e.g. encoding and decoding) and associated operations, the peripheral sub-system 130 is capable of control peripheral modules/devices, the memory interface 180 is capable of perform access control of some memories such as those shown in FIG. 1A, and the top fabric 190 is capable of interconnect different portions of the processing circuit. Additionally, the PLL unit 150 illustrated around the upper left of FIG. 1A is capable of perform phase locking operations, and the aforementioned I/O modules and/or interface modules (e.g. those electronically connected to the multimedia sub-system 120) are capable of perform I/O control and/or interface control.

In this embodiment, the apparatus for performing scenario driven voltage scaling of the system 100 can be at least a portion of the CPU sub-system 110. For example, the processor such as the CPU in the CPU sub-system 110 may execute program codes to perform scenario change detection, table looking-up, and/or voltage selection. In addition, after the table looking-up is performed and the required voltage level is selected, the processor executing the program codes may set the PMIC 340. More particularly, after the table looking-up is performed to determine the requirement of operational frequency, the processor executing the program codes may set the PLL 150.

FIG. 1B illustrates some implementation details of the apparatus for performing scenario driven voltage scaling of the system 100 shown in FIG. 1A according to an embodiment of the present invention. Regarding the components/modules/units shown in FIG. 1B, some of them can be implemented with at least one hardware circuit, some of them can be implemented with at least one software module, and some of them can be implemented with a combination of at least one hardware circuit and at least one software module, where some of the components/modules/units shown in FIG. 1B may comprise at least one portion (e.g. a portion or all) of a component/module/unit shown in FIG. 1A. For example, the smart power management module 310 (labeled “SPM” in FIG. 1B) can be a software module, the multimedia middleware scenario driven power management module 322 (labeled “Multimedia Middleware SDPM” in FIG. 1B) can be a middleware, the micro control unit system (MCUSYS) bus monitor task 324 (labeled “MCUSYS BMT” in FIG. 1B) and some drivers such as the audio driver 332, the video driver 334, the three dimensional (3D) engineering driver 336, and the PMIC driver 305 can be software modules, and the PMIC 340, the video front end/audio front end (VFE/AFE) 342, the Moving Picture Experts Group-4 (MPEG-4) unit 344 (labeled “MPEG-4” in FIG. 1B), the 3D engineering unit 346 (labeled “3D engineering” in FIG. 1B), the peripheral module 348 (labeled “Peripheral” in FIG. 1B), and the bus 350 can be implemented with at least one hardware circuits. In some embodiments, the PMIC 340 can be implemented within the apparatus for performing scenario driven voltage scaling. This is for illustrative purposes only, and is not meant to be a limitation of the present invention. According to a variation of this embodiment, the PMIC 340 can be separated from the apparatus for performing scenario driven voltage scaling.

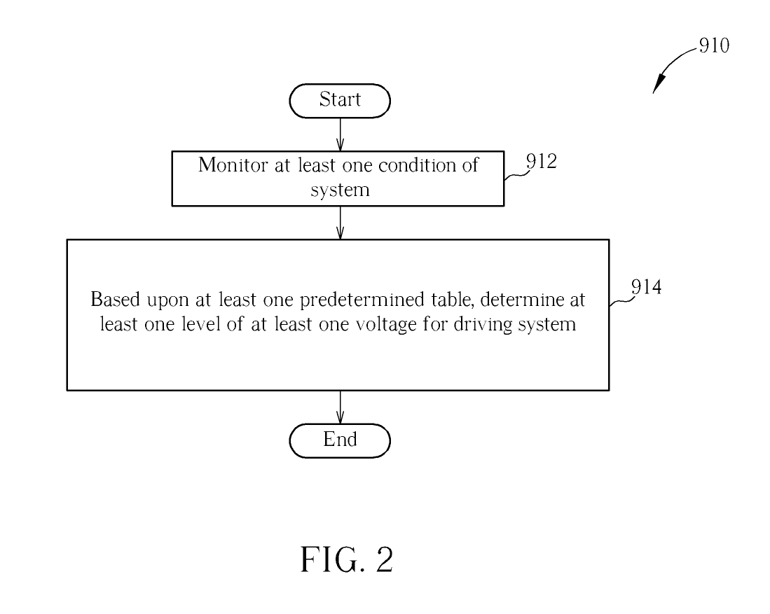

According to this embodiment, the apparatus for performing scenario driven voltage scaling may comprise at least one tracking module and at least one voltage control module, such as some of the components/modules/units disclosed in FIG. 1B. Referring to FIG. 2, related operations of the aforementioned at least one tracking module and the aforementioned at least one voltage control module can be described as follows.

FIG. 2 is a flowchart of a method for performing scenario driven voltage scaling of a system according to one embodiment of the present invention. The method can be applied to the apparatus and system of any of the embodiments shown in FIGS. 1A-1B (and variations thereof). In addition, the method can be implemented by utilizing the apparatus shown in any of the embodiments shown in FIGS. 1A-1B (and variations thereof). The method 910 is described as follows.

In Step 912, the aforementioned at least one tracking module is capable of monitoring at least one condition of the system 100, where the at least one condition may include user scenario switching of the system. More particularly, the at least one condition may further include temperature variation of the system 100 and at least one chip condition of the system 100, where the chip condition can include a process variation of the system 100. In one embodiment, the aforementioned at least one tracking module monitors the chip condition once when the main power of the system 100 is turned on.

In practice, for the same requirement of operational frequency, when the temperature of the system 100 increases, the required voltage level should be increased. Thus, the temperature variation of the system 100 can be included in the aforementioned at least one condition. In addition, due to the process variation of the system 100, some components may operate faster than others within integrated circuits. For example, the integrated circuits may respectively be classified as the so-called SS/TT/FF (slow/typical/fast). When the same voltage level is applied, the operating speed of those classified as FF may be 120% of that of those classified as SS, where for the same requirement of operational frequency, the required voltage level of those classified as FF may be lower than that of those classified as SS.

In Step 914, based upon at least one predetermined table, such as at least one predetermined table within the system 100 (e.g. a single predetermined table implemented within a certain component/module/unit such as one of the component/module/units shown in FIG. 1A, or multiple predetermined tables that distribute over some of the component/module/units shown in FIG. 1A), the aforementioned at least one voltage control module is capable of determining at least one level of at least one voltage for driving the system 100 according to the at least one condition, where the predetermined table may include a plurality of sets of frequency/voltage information respectively corresponding to a plurality of scenarios. In particular, the aforementioned at least one voltage may include a plurality of voltages for driving a plurality of sub-systems of the system 100, respectively. For example, the sub-systems mentioned above can be some of the components/modules/units shown in any of FIGS. 1A-1B.

According to this embodiment, the aforementioned at least one predetermined table can be very simple for the aforementioned at least one voltage control module to rapidly determine the at least one level mentioned in Step 914. For example, as the required voltage level(s) and/or the requirement of the operational frequency (frequencies) for the sub-systems can be determined in advance during the design phase of the system 100, and as the required voltage level(s) and/or the requirement of the operational frequency (frequencies) for a specific scenario of the plurality of scenarios can be determined in advance during the design phase of the system 100, the aforementioned at least one predetermined table may merely include a plurality of predetermined frequencies/voltages respectively corresponding to the scenarios. Thus, when the system 100 is operating, the aforementioned at least one voltage control module can rapidly determine the required frequency/voltage corresponding to the scenario under consideration. This is for illustrative purposes only, and is not meant to be a limitation of the present invention. According to some variations of this embodiment, the aforementioned at least one predetermined table may store at least one logic synthesis result, where the aforementioned at least one logic synthesis result represents at least one set of frequency/voltage information corresponding to at least one scenario. For example, in one of these variations, the aforementioned at least one logic synthesis result can be determined in advance during a design phase of the system 100. According to some variations of this embodiment, the apparatus can perform at least one determination operation to generate/update content(s) of the predetermined table. For example, the at least one determination operation comprises at least one logic synthesis operation. According to some variations of this embodiment, based upon the predetermined table, the voltage control module is capable of determining respective voltage levels required for respectively driving a plurality of sub-systems of the system 100, and selecting a maximum of the respective voltage levels as the aforementioned at least one level of the aforementioned at least one voltage in Step 914. In addition, based upon the predetermined table, the voltage control module is capable of determining at least one frequency associated to at least one of the respective voltage levels mentioned above.

Here, the architecture disclosed in FIG. 1B can be taken as an example. Referring to the left half of FIG. 1B, the multimedia middleware scenario driven power management module 322 can obtain clock information from the audio driver 332, the video driver 334, the 3D engineering driver 336, and can determine a minimum voltage level required (labeled “Acceptable Minimum Voltage” at an output of the multimedia middleware SDPM (scenario driven power management module) 322 and notify the audio driver 332, the video driver 334, the 3D engineering driver 336 of the scenario switching, respectively. In addition, the audio driver 332, the video driver 334, the 3D engineering driver 336 can perform audio clock setting, video clock setting, and 3D engineering clock setting on the VFE/AFE 342, the MPEG-4 unit 344, and the 3D engineering unit 346, respectively. Referring to the right half of FIG. 1B, the MCUSYS BMT (bus monitor task) 324 can get bus information from hardware (HW) such as the peripheral module 348 and the bus 350, and can determine a minimum voltage level required (labeled “Acceptable Minimum Voltage” at an output of the MCUSYS bus monitor task 324) and perform frequency setting on the peripheral module 348.

By comparing the two minimum voltage levels determined by the multimedia middleware scenario driven power management module 322 and the MCUSYS bus monitor task 324, the smart power management module 310 can perform voltage level setting on the PMIC driver 305 based upon the maximum of the two minimum voltage levels. As a result, the PMIC driver 305 is capable of controlling the PMIC 340 to apply a voltage having the maximum of the two minimum voltage levels to the VFE/AFE 342, the MPEG-4 unit 344, the 3D engineering unit 346, the peripheral module 348, and the bus 350, respectively. According to a variation of this embodiment, in a situation where there are multiple voltages to be respectively applied to the VFE/AFE 342, the MPEG-4 unit 344, the 3D engineering unit 346, the peripheral module 348, and the bus 350, the smart power management module 310 can perform voltage level setting on the PMIC driver 305 based upon a varied version of the algorithm of the architecture disclosed in FIG. 1B.

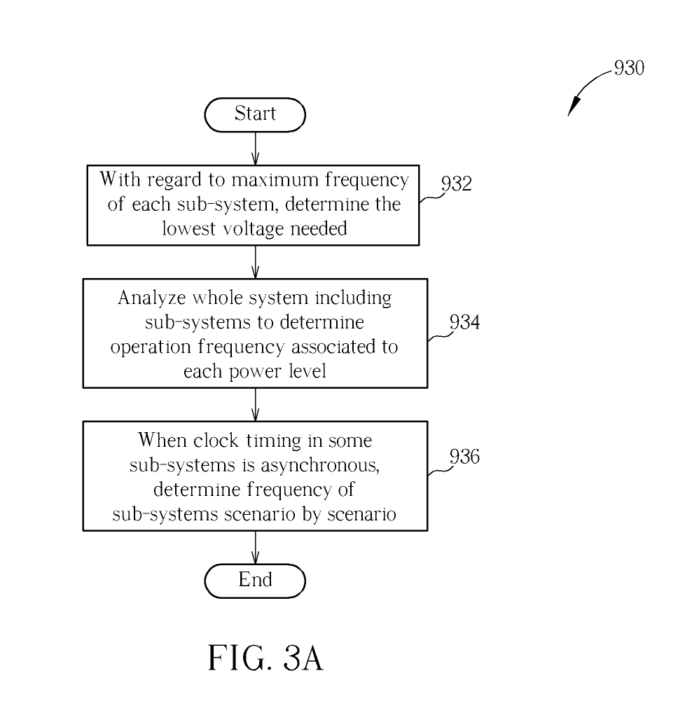

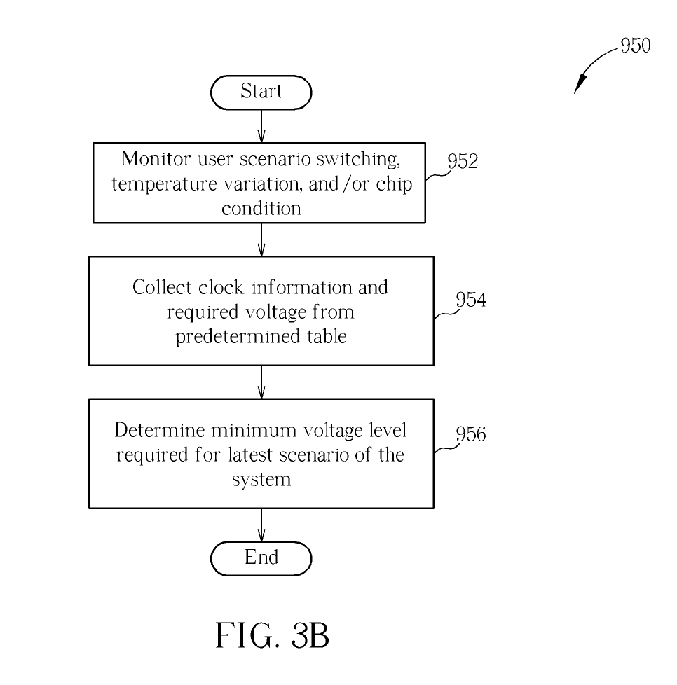

FIGS. 3A-3B illustrate some implementation details of the method 910 shown in FIG. 2 according to some embodiments of the present invention. Please note that the working flow 930 shown in FIG. 3A can be utilized for implementing the aforementioned at least one predetermined table, and the working flow 950 shown in FIG. 3B can be utilized for implementing the voltage control disclosed in the embodiment shown in FIG. 2.

Referring to FIG. 3A, in Step 932, with regard to the maximum frequency of each sub-system, the lowest voltage needed is determined.

In Step 934, the whole system including the sub-systems is analyzed to determine the operation frequency associated to each power level.

In Step 936, when clock timing in some sub-systems is asynchronous, at least one frequency (e.g. one or more frequencies) of the sub-systems such as the 3D engineering unit 346, the MPEG-4 unit 344, and the VFE/AFE 342 disclosed above is determined scenario by scenario, where examples of the scenarios may comprise various kinds of applications such as play MP3, play MPEG4, and various kinds of resolutions, such as the resolutions of Video Graphics Array (VGA), Quarter VGA (QVGA), Super VGA (SVGA), and Extended Graphics Array (XGA).

Referring to FIG. 3B, in Step 952, at least one condition of the system 100, such as user scenario switching, temperature variation, and/or chip condition, can be monitored by the aforementioned at least one tracking module, such as at least one software driver disclosed above (e.g. one or more software drivers) or any other hardware, firmware, software, or combination thereof.

In Step 954, clock information (e.g. the frequency of a clock) and the required voltage can be collected from the predetermined table by the software driver or any other hardware, firmware, software, or combination thereof.

In Step 956, the minimum voltage level required for the latest scenario of the system 100 can be determined by the PMIC driver 305 or any other hardware, firmware, software, or combination thereof.

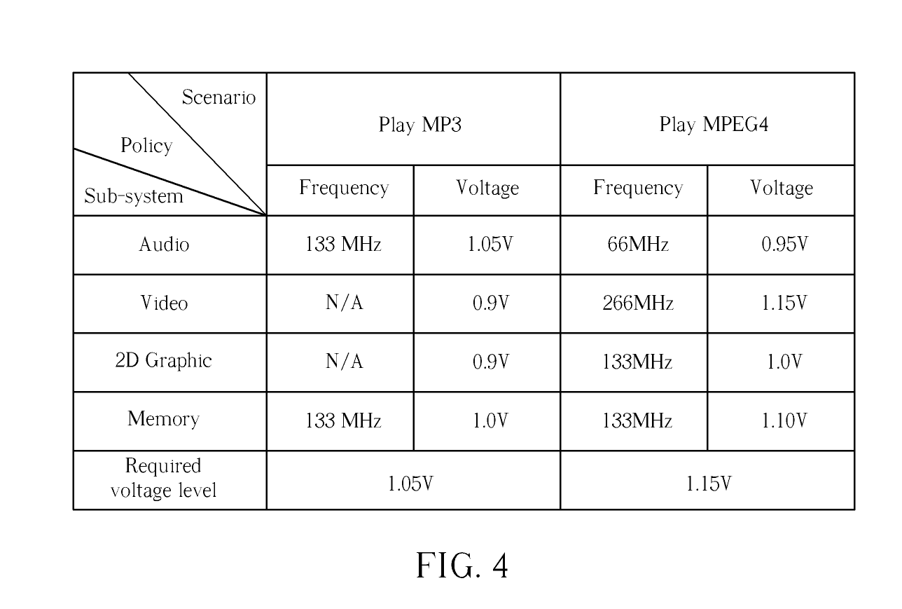

FIG. 4 illustrates an exemplary table involved with the method 910 shown in FIG. 2 according to an embodiment of the present invention. The table shown in FIG. 4 can be taken as an example of the aforementioned at least one predetermined table in Step 914. In this embodiment, examples of the conditions may comprise various kinds of operations such as an operation of playing MPEG audio layer 3 (MP3) files (labeled “Play MP3” in FIG. 4) and an operation of playing MPEG-4 files (labeled “Play MPEG4” in FIG. 4). In addition, examples of the sub-systems may comprise an audio module/unit (e.g. an AFE within the VFE/AFE 342), a video module/unit (e.g. the MPEG-4 unit 344), a two dimensional (2D) graphic module/unit (e.g. a graphic unit within the multimedia sub-system 120), and a memory control module/unit (e.g. a bus and associated circuit regarding the memory interface 180), which are labeled “Audio”, “Video”, “2D Graphic”, and “Memory” around the leftmost of the table shown in FIG. 4, respectively.

According to this embodiment, the aforementioned at least one predetermined table may store at least one logic synthesis result, where the aforementioned at least one logic synthesis result represents at least one set of frequency/voltage information corresponding to at least one scenario. This by no means implies that the apparatus should perform the aforementioned logic synthesis operation since, as mentioned, the aforementioned at least one logic synthesis result can be determined in advance during the design phase of the system 100. In addition, the policies may represent at least one portion (e.g. a portion or all) of the plurality of sets of frequency/voltage information mentioned in Step 914. For example, as a result of executing Step 912, the aforementioned at least one voltage control module can be notified of the latest user scenario switching, and can determine that the latest user scenario is the scenario “Play MP3” and obtain the logic synthesis results such as some sets of frequency/voltage information listed under the scenario “Play MP3” in the table shown in FIG. 4. The maximum of the voltage levels {1.05, 0.9, 0.9, 1.0} in units of Volts (V) within the sets of frequency/voltage information corresponding to the scenario “Play MP3” is 1.05 V. That is, the required voltage level is 1.05 V. Thus, the aforementioned at least one level of the aforementioned at least one voltage determined in Step 914 can be 1.05 V. In another example, as a result of executing Step 912, the aforementioned at least one voltage control module can be notified of the latest user scenario switching, and can determine that the latest user scenario is the scenario “Play MPEG4” and obtain the logic synthesis results such as some sets of frequency/voltage information listed under the scenario “MPEG4” in the table shown in FIG. 4. The maximum of the voltage levels {0.95, 1.15, 1.0, 1.10} in units of Volts (V) within the sets of frequency/voltage information corresponding to the scenario “Play MPEG4” is 1.15 V. That is, the required voltage level is 1.15 V. Thus, the aforementioned at least one level of the aforementioned at least one voltage determined in Step 914 can be 1.15 V. Similar descriptions for this embodiment are not repeated in detail here.

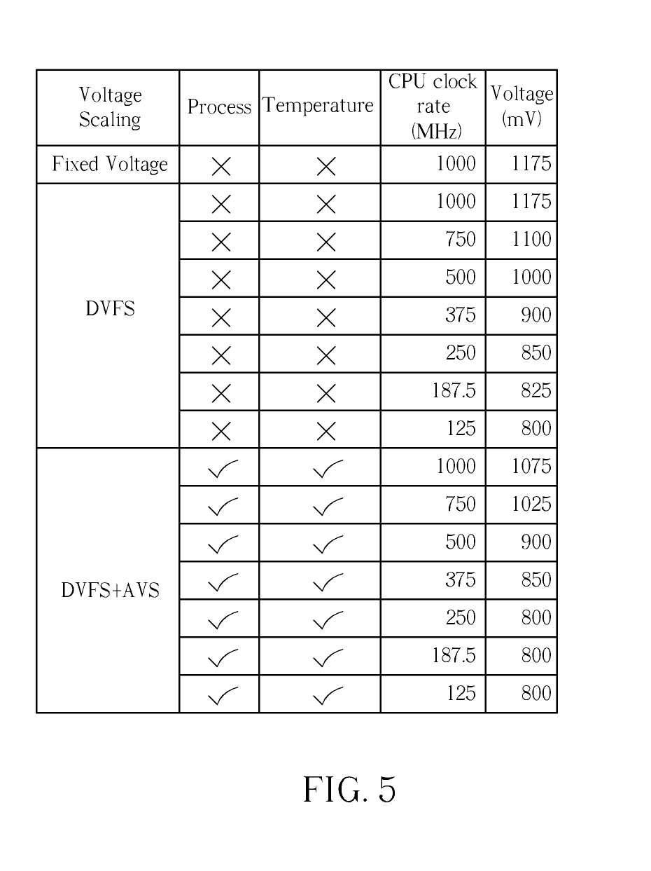

FIG. 5 illustrates an exemplary table involved with the method 910 shown in FIG. 2 according to another embodiment of the present invention. The table shown in FIG. 5 can be taken as an example of the aforementioned at least one predetermined table in Step 914. In this embodiment, examples of the conditions may comprise various kinds of modes such as a fixed voltage mode (labeled “Fixed Voltage” in FIG. 5), a dynamic voltage frequency scaling (DVFS) mode (labeled “DVFS” in FIG. 5), a combination mode of DVFS and adaptive voltage scaling (AVS) (labeled “DVFS+AVS” in FIG. 5). In the table shown in FIG. 5, the column labeled “Process” is utilized for denoting whether monitoring the chip condition of the system 100 (e.g. the process variation of the system 100) is required, and the column labeled “Temperature” is utilized for denoting whether monitoring the temperature variation of the system 100 is required. Please note that the notation “X” in this table means “Don't care”, and the notation “V” in some fields within the columns labeled “Process” and “Temperature” indicates that both monitoring the chip condition of the system 100 and monitoring the temperature variation of the system 100 are required. Additionally, the column labeled “CPU clock rate (MHz)” represents the clock rate (or the frequency) of the CPU mentioned above, and the column labeled “Voltage (mV)” represents the voltage to be applied to the system 100 corresponding to the CPU clock rate.

In practice, for the same requirement of operational frequency, when the temperature of the system 100 increases, the required voltage level should be increased. Thus, the temperature variation of the system 100 can be included in the aforementioned at least one condition. In addition, due to the process variation of the system 100, some components may operate faster than others within integrated circuits. For example, the integrated circuits may respectively be classified as the so-called SS/TT/FF (slow/typical/fast). When the same voltage level is applied, the operating speed of those classified as FF may be 120% of that of those classified as SS, where for the same requirement of operational frequency, the required voltage level of those classified as FF may be lower than that of those classified as SS. Similar descriptions for this embodiment are not repeated in detail here.

It is an advantage of the present invention that, based upon the aforementioned at least one predetermined table, the present invention method and apparatus can properly determine the aforementioned at least one level of the aforementioned at least one voltage for driving the system. As a result, the present invention can achieve the goal of saving power without reducing the performance of the system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing scenario driven voltage scaling of a system, the method comprising:
monitoring at least one condition of the system, wherein the at least one condition comprises user scenario switching of the system; and
based upon at least one predetermined table, determining at least one level of at least one voltage for driving the system according to the at least one condition, wherein the predetermined table comprises a plurality of sets of frequency/voltage information respectively corresponding to a plurality of scenarios.

2. The method of claim 1, wherein the at least one condition further comprises temperature variation of the system.

3. The method of claim 1, wherein the at least one condition further comprises at least one chip condition of the system.

4. The method of claim 3, wherein the chip condition corresponds to a process variation of the system.

5. The method of claim 1, wherein the at least one voltage comprises a plurality of voltages for driving a plurality of sub-systems of the system, respectively.

6. The method of claim 1, wherein the at least one predetermined table stores at least one logic synthesis result, and the at least one logic synthesis result represents at least one set of frequency/voltage information corresponding to at least one scenario.

7. The method of claim 1, further comprising:
performing at least one determination operation to generate/update content(s) of the predetermined table.

8. The method of claim 7, wherein the at least one determination operation comprises at least one logic synthesis operation.

9. The method of claim 1, wherein the step of determining the at least one level of the at least one voltage for driving the system further comprises:
based upon the predetermined table, determining respective voltage levels required for respectively driving a plurality of sub-systems of the system, and selecting a maximum of the respective voltage levels as the at least one level of the at least one voltage.

10. The method of claim 9, wherein the step of determining the at least one level of the at least one voltage for driving the system further comprises:
based upon the predetermined table, determining at least one frequency associated to at least one of the respective voltage levels.

11. An apparatus for performing scenario driven voltage scaling of a system, the apparatus comprising:
at least one tracking module capable of monitoring at least one condition of the system, wherein the at least one condition comprises user scenario switching of the system; and
at least one voltage control module, wherein based upon at least one predetermined table, the voltage control module is capable of determining at least one level of at least one voltage for driving the system according to the at least one condition, wherein the predetermined table comprises a plurality of sets of frequency/voltage information respectively corresponding to a plurality of scenarios.

12. The apparatus of claim 11, wherein the at least one condition further comprises temperature variation of the system.

13. The apparatus of claim 11, wherein the at least one condition further comprises at least one chip condition of the system.

14. The apparatus of claim 13, wherein the chip condition corresponds to a process variation of the system.

15. The apparatus of claim 11, wherein the at least one voltage comprises a plurality of voltages for driving a plurality of sub-systems of the system, respectively.

16. The apparatus of claim 11, wherein the at least one predetermined table stores at least one logic synthesis result, and the at least one logic synthesis result represents at least one set of frequency/voltage information corresponding to at least one scenario.

17. The apparatus of claim 11, wherein the apparatus performs at least one determination operation to generate/update content(s) of the predetermined table.

18. The apparatus of claim 17, wherein the at least one determination operation comprises at least one logic synthesis operation.

19. The apparatus of claim 11, wherein based upon the predetermined table, the voltage control module is capable of determining respective voltage levels required for respectively driving a plurality of sub-systems of the system, and selecting a maximum of the respective voltage levels as the at least one level of the at least one voltage.

20. The apparatus of claim 19, wherein based upon the predetermined table, the voltage control module is capable of determining at least one frequency associated to at least one of the respective voltage levels.
